(19) United States
(12) Patent Application Publication
(10) Pub. No.: US 2007/0231114 A1
(43) Pub. Date: Oct. 4, 2007

(54) Transportation Trailer Utilizing Tower Support Structure and Method of Forming Same

(76) Inventor: William P. Westrate, CASSOPOLIS, MI (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 11/278,304

(22) Filed: Mar. 31, 2006

(51) Int. Cl. B60P 1/00

(52) U.S. Cl. 414/545

(57) ABSTRACT

A transportation trailer (100) includes a trailer bed (103), a gate (119), lifting mechanism (111, 113) and tower support structures (107, 109). The tower support structure (107, 109) is used to support the lifting mechanism for moving the gate (119) between an open and closed positions where the gate (119) may be raised above, below, or in a plane with the bed (103) for allowing vehicles or other heavy equipment to be easily stowed on the trailer bed (103) with minimal effort.

### FIELD OF THE INVENTION

The present invention relates generally to a transportation trailer and more particularly to a trailer having a tower support structure for controlling operation of a hinged access door.

### BACKGROUND OF THE INVENTION

Carrier trailers and wheeled transport units are commonly used with motorized vehicles which enable the users to carry large loads for increasing utility of their vehicles. Typical examples of transport trailers include U.S. Pat. No. 4,647,270 to Maloney that discloses a beaver tail section with foldable ramp for enabling vehicles to be driven onto the trailer. U.S. Pat. No. 5,678,984 to Petersen teaches a detachable folding trailer ramp that includes a pivotable rear section for moving vehicles to a truck bed. Finally, U.S. Pat. No. 5,829,947 to Litten teaches a cargo handling hydraulic ramp loader and lifting cylinder to level the ramp for vehicle access.

One problem associated with these types of trailers and wheeled transport units is that they typically include complex hydraulic lifting units that extend under the foldable ramp. These types of mechanical arrangements are more difficult to manufacture and often require continual repair and maintenance. Thus, the need exists to provide a new type of carrier trailer having a low manufacturing cost yet which is structurally robust for enabling the trailer to include an easy-to-use hydraulic ramp for moving heavy objects or other vehicles onto the trailer bed.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustration depicting operation of the transportation trailer with the gate in a closed position in accordance with an embodiment of the invention.

FIG. 2 is an illustration depicting operation of the transportation trailer with the gate in an open position in accordance with an alternative embodiment of the invention.

FIG. 3 is an illustration depicting operation of the transportation trailer with the gate in a lowered position that is in full contact the ground in accordance with an alternative embodiment of the invention.

FIG. 4 is an illustration depicting operation of the transportation trailer with the gate in a raised position in a plane substantially parallel with the trailer bed in accordance with an alternative embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a transportation trailer having a tower structure. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

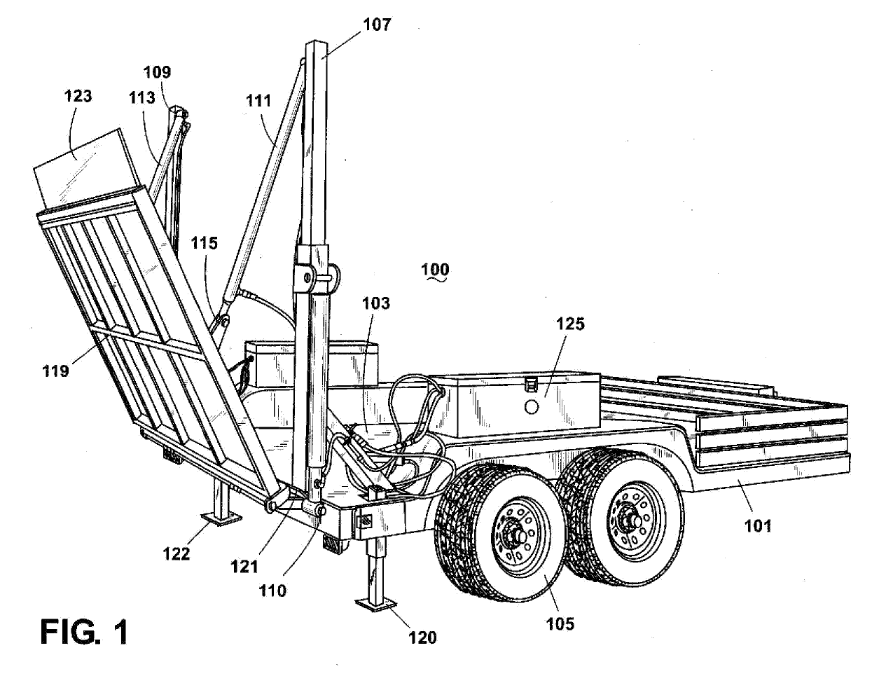

FIG. 1 illustrates the transportation trailer 100 in accordance with the invention where a gate in a raised into a retracted position. A trailer frame 101 is used in combination with a metallic bed 103 and wheels 105 to form a support structure that is capable of transporting large and/or heavy objects. The transportation trailer 100 includes a plurality of tower supports 107, 109 which extend substantially vertically from the rear edge 111 of the bed 103. The tower supports 107, 109 are semi-retractable in that they are divided into two or more telescoping sections that can be moved up or down using a plurality of first hydraulic lifting cylinders 110, 112 that are located at the lower end of each tower support 107, 109. The lower section of the tower supports 107, 109 include sleeves 114, 116 that work with lifting cylinders 110, 112 to guide the respective tower supports 107, 109 therethrough. The tower supports 107, 109 may be positioned such that they extend above or below sleeves 114, 116. Each sleeve 114, 116 remains unretractable and is in a fixed, substantially vertical position in relation to the bed 103.

A plurality of second hydraulic lifting cylinders 111, 113 are attached to an upper end of each of the tower supports 107, 109 and are controlled by a hydraulic control mechanism on the trailer 100. The lifting cylinders 111, 113 are connected at their opposite ends to respective pivotable extension members 115, 117. The extension members 115, 117 are connected at the midsection of gate 119 that is hinged at one end to the rear section 121 of bed 103. Additionally, a plurality of outriggers 120, 122 extend from the trailer bed 103 to the ground, which enable the trailer to maintain stability when large amounts of weight are supported by the gate 119. Those skilled in the art will recognize that the outriggers 120, 122 prevent the trailer bed 103 from pivoting rearwardly about the wheels 105 and act to maintain stability and enhance safety of the trailer. Those skilled in the art will also recognize the hydraulic lifting cylinders 110, 112 and lift cylinders 111, 113 are operated by one or more hydraulic power units (not shown). Each hydraulic power unit consists of 12-volt direct current (DC) hydraulic pump and power hydraulic piston cylinder and associated reservoir that operates to control the length of its respective cylinder. Each hydraulic power unit is housed in an enclosure 125.

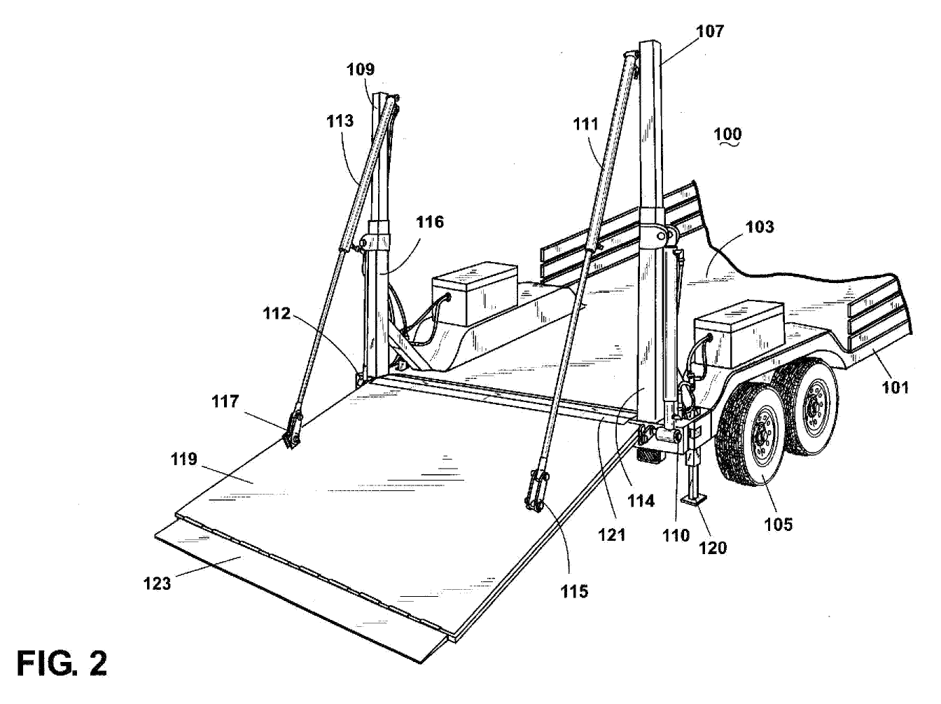

FIG. 2 shows further details of the gate 119 extended into its lowered position, where a gate extension 122 extends from the rear edge of the gate and is used to make contact with the ground or other firm surface. This allows vehicles or other heavy equipment to be pushed or driven onto the surface of the gate 19 where they can then be moved onto the bed 103.

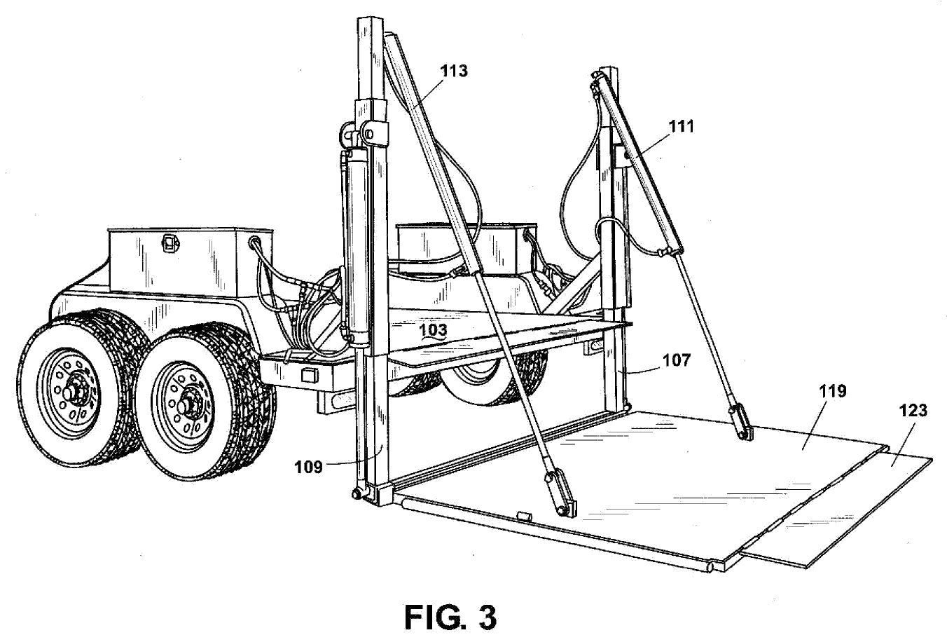

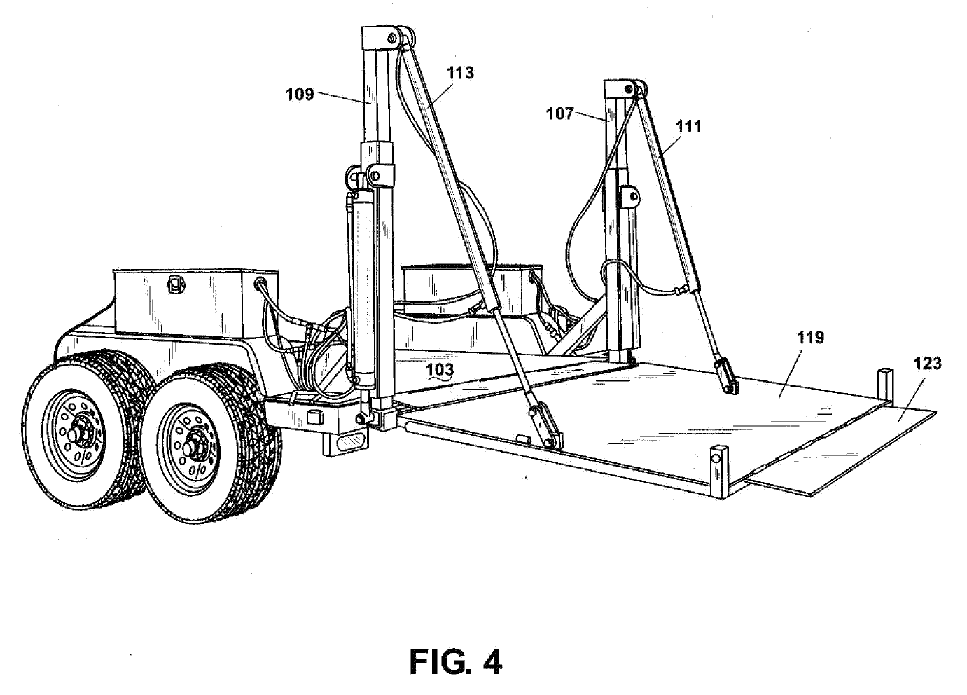

FIGS. 3 and 4 illustrate yet other embodiments of the invention where the gate 119 is extended to a position where it is substantially parallel with the ground. In FIG. 3, the gate 119 is lowered to the ground using tower supports 107, 109. The gate is positioned in full contact with the ground or other support surface, enabling vehicles or other heavy equipment to be moved directly onto the bed 103. As seen in FIG. 4, the gate 119 is raised such that it is flat and is in a plane substantially parallel with bed 103. Once raised into this position, heavy objects and equipment can be moved directly onto the bed 103 with minimal effort.

Thus, the invention is a transportation trailer having tower structures that extend vertically above or below the trailer bed. The tower structures work to support a plurality of hydraulic lifting cylinders that attach to a pivotable rear gate attached to the rear of the trailer bed. In one embodiment, the gate may be raised below the trailer bed to come into full ground contact or, alternatively, may be raised into a position where it is in a plane substantially parallel with the bed. The invention works to provide a low-cost, easy-to-manufacture solution for lifting and moving heavy objects and vehicles onto the trailer bed.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A transportation trailer comprising:
a trailer bed;
a gate; at least one first lifting mechanism;
at least one tower support structure positioned above the rear of the trailer bed; and
wherein the at least one tower support structure supports the at least one lifting mechanism for moving the gate between a substantially open and closed position.

2. A transportation trailer as in claim 1, wherein the at least one lifting mechanism is a hydraulic lift.

3. A transportation trailer as in claim 1, wherein the at least one tower support structure includes a second lifting mechanism for extending the at least one tower support structure a predetermined distance above the trailer bed.

4. A transportation trailer as in claim 1, further comprising at least one outrigger extending from the trailer bed for contacting the ground for providing stability.

5. A transportation trailer as in claim 1, wherein the at least one tower support structure is moveable below the trailer bed enabling the gate to be positioned substantially flat against the ground.

6. A transportation trailer for transporting objects pulled behind a motorized vehicle comprising:
a frame for supporting a trailer bed;
a gate positioned at the rear of the trailer bed;
at least one tower support structure extending substantially vertically from the rear of the trailer bed; and
at least one first lifting mechanism extending between the at least one tower support structure and the trailer frame for moving the gate between an extended and retracted position.

7. A trailer for transporting objects as in claim 6, further comprising at least one second lifting mechanism for positioning the at least one tower structure a predetermined distance above the trailer bed.

8. A trailer for transporting objects as in claim 6, wherein the at least one tower structure is a telescoping member.

9. A trailer for transporting objects as in claim 6, wherein the at least one first lifting mechanism is operated hydraulically.

10. A trailer for transporting objects as in claim 6, further comprising at least one outrigging member extending from the frame for providing stability against the ground.

11. A trailer for transporting objects as in claim 6, wherein the at least one tower support structure is moveable below the trailer bed enabling the gate to be positioned substantially flat against the ground.

12. A method for utilizing a tower support structure on a transportation trailer comprising the steps of:
attaching at least one tower support structure to the rear of a trailer bed;
positioning a first lifting mechanism between the at least one tower support structure and a gate; and
moving the first lifting mechanism such that the gate moves between an open and closed position.

13. A method for utilizing a tower support structure as in claim 12, further including the step of:
positioning a second lifting mechanism for extending the at least one tower support structure a predetermined height above the trailer bed.

14. A method for utilizing a tower support structure as in claim 13, wherein the first lifting mechanism and the second lifting mechanism are hydraulically operated.

15. A method for utilizing a tower support structure as in claim 12, wherein the at least one tower support structure is a telescoping member.

16. A method for utilizing a tower support structure as in claim 12, further including the step of:
attaching at least one outrigging member to the trailer bed for providing support against the ground.

17. A method for utilizing a tower support structure as in claim 12, further including the step of:
moving the at least one tower support structure below the trailer bed for enabling the gate to be positioned substantially flat against the ground.
